(19) United States
(12) Patent Application Publication
(10) Pub. No.: US 2015/0024926 A1
(43) Pub. Date: Jan. 22, 2015

(54) METHOD FOR PRODUCING SUPPORTED IONIC-LIQUID PRODUCTS

(71) Applicant: CHEMTECH RESEARCH INCORPORATION, Namyangju-si (KR)

(72) Inventors: Jung Bok Ryu, Suwon-si (KR); Duck Soo Yuk, Seoul (KR); Kuk Jin Jang, Gwangyang-si (KR); So Kyoung Joo, Seongnam-si (KR); Wan Joo Kim, Seoul (KR)

(21) Appl. No.: 14/383,539

(22) PCT Filed: Mar. 6, 2013
(86) PCT No.: PCT/KR2013/001809

§ 371 Date: Sep. 5, 2014

(30) Foreign Application Priority Data
Mar. 7, 2012 (KR) 10-2012-0023370

(51) Int. Cl. B01J 31/26

(52) U.S. Cl. CPC B01J 31/26
USPC 502/167

(57) ABSTRACT

The present invention relates to a preparation method, which involves synthesizing BMIM/Cl, which is an ionic liquid, from AlCl₃ and TiCl₄, which are Lewis acids, and which enables the synthesized body to be supported by Al₂O₃ serving as a support. The preparation method of the present invention uses AlCl₃ and TiCl₄, which are not used in existing methods, so as to prepare a supported ionic liquid. The preparation method of the present invention uses water as a solvent to efficiently relieve reaction conditions and avoid the risk of heating during the reaction, and thus enables supported ionic-liquid products to be continuously prepared in a stable manner.

### TECHNICAL FIELD

The present invention is related to a method for producing powder-type ionic-liquid phase product having high thermal stability produced by reacting ionic liquid which is a salt or salt compound being stable at high temperature and having the melting point of 100° C. or less with AlCl₃ or TiCl₄ as Lewis acid to synthesize intermediate of ionic-liquid phase, and depositing Al₂O₃ which is a porous support to the intermediate.

The present invention is related to a method for producing supported ionic-liquid phase product which has pore in a particle thereby having gas separation ability, can be applied to such as release coating catalyst and biocatalyst, nanoparticle catalyst and organic metal catalyst as transition metal catalyst, and has an ability of chemical conversion of novel concept.

### BACKGROUND ART

Ionic liquid is a compound composed of organic cation and anion and exists as liquid at 100° C. or below. The examples of cation are alkylimidazolium, alkylpyrrolidinium, alkylpyridinium, tetraalkylammonium, tetraalkylphosphonium and so on, and the examples of anion are BF₄, PF₆, NO₃, AlCl₄, NTF₂, OTf, OAc, SbF₆ and so on. The ionic liquid is applied and used in various fields such as organic alternative solvent, catalyst, electrochemisty, bionics and etc. However, ionic-liquid phase combined with Lewis acid and supported thereby is not commonly used yet.

Thus, since the range of application of the ionic-liquid phased is being expanded as described above, improved synthesis of supported ionic-liquid phase is being required.

### DISCLOSURE OF THE INVENTION

### Problems to be Solved by the Invention

The purpose of the present invention is providing a method for producing supported ionic-liquid phase product for chemical conversion by using a Lewis acid such as AlCl₃ and TiCl₄.

### Means for Solving the Problems

In accordance with an illustrated embodiment of the present invention, there is provided a method for producing powder-type ionic-liquid phase product having high thermal stability, comprising a step of reacting 1-butyl-3-methylimidazolium chloride [BMIM]Cl with AlCl₃ or TiCl₄ as Lewis acid to synthesize [BMIM]Cl/AlCl₃ or [BMIM]Cl/TiCl₄ which is an intermediate of ionic-liquid phase; and a step of depositing Al₂O₃ which is a porous support to the intermediate.

In accordance with the present invention, it is characterized in that the 1-butyl-3-methylimidazolium chloride [BMIM]Cl and the AlCl₃ or TiCl₄ as Lewis acid are reacted in concentrations of from 0.1 M to 0.2 M and 0.12 M to 0.24 M, respectively.

The present invention is characterized in that the intermediate of ionic-liquid phase is subjected to vacuum evaporation under 1 atmosphere, at 70° C.˜75° C. for 1˜2 hours during synthesizing process.

The present invention is characterized in that the intermediate of ionic-liquid phase is produced by dissolving in a solvent including methylene chloride and water.

The present invention is characterized in that the intermediate of ionic-liquid phase dissolved in the solvent is being mixed and stirred with Al₂O₃ as a support in a weight ratio of 1:1 to 1:3 to be supported by Al₂O₃.

The present invention is characterized in that the intermediate of ionic-liquid phase is subjected to vacuum evaporation under 1 atmosphere, at a inner temperature of 50° C.-55° C. for about 1 hour to about 2 hours.

### Effect of the Invention

According to present invention, firstly, supported ionic-liquid phase product can be produced safely.

A newly developed supported ionic-liquid phase product according to the method of the present invention is thermally stable.

Also, the method for producing supported ionic-liquid phase product of the present invention can increase reaction stability by using water instead of conventional reaction solvent to stably obtain liquid phase intermediate [BMIM]Cl/AlCl₃, [BMIM]Cl/TiCl₄. Furthermore, the method for producing supported ionic-liquid product of the present invention has effects such as facilitating scale-up, decreasing costs for design, investment and operation, improving synthesis yield by reducing raw materials, solvent, waste and energy, improving chemical purity and decreasing the unit cost of production.

### BRIEF DESCRIPTION OF THE DRAWINGS

FIG. 1 provides a photograph of a moisture analyzer for measuring water content of [BMIM]Cl/AlCl₃, [BMIM]Cl/TiCl₄.

FIG. 2 provides an image of solid form of supported ionic-liquid phase of [BMIM]Cl/AlCl₃/Al₂O₃.

FIG. 3 provides an image of solid form of supported ionic-liquid phase of [BMIM]Cl/TiCl₄/Al₂O₃.

### BEST MODE FOR CARRYING OUT THE INVENTION

A supported ionic-liquid phase product of novel concept in accordance with the present invention is produced by combining ionic liquid which is salt or salt compound with Lewis acid, which is not conventionally used, for example, but it may not limited to, AlCl₃, TiCl₄, and dispersing it as a thin film on inner surface of Al₂O₃ which is a support material having high porosity.

In addition to the Lewis acid stated above, the Lewis acids able to be used in the present invention include FeCl₃, ZnCl₂, SbF₅, BF₃, and HCl, H₂SO₄, H₃PO₄ and HF which are Bronsted acid.

As the ionic-liquid phase product of the present invention, for example, [BMIM-Cl][SnCl₂][Al₂O₃], [BMIM-Cl][ZnCl₂][Al₂O₃], [OMIM-Cl][SnCl₂][Al₂O₃] or [C₁₂MIM-Cl][SnCl₂][Al₂O₃] can be synthesized respectively. Newly developed supported ionic-liquid phase products are two types of [BMIM-Cl][TiC1₄][Al₂O₃] or [BMIM-Cl][AlCl₃][Al₂O₃] which are developed by using new Lewis acid, and they may be synthesized for chemical conversion reaction.

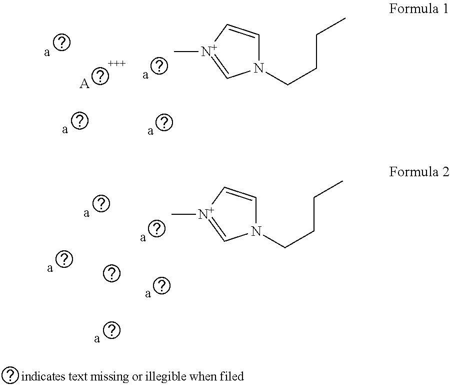

The formulae 1 and 2 above correspond to [BMIM]Cl/AlCl₃ and [BMIM]Cl/TiCl₄ respectively, which are intermediates of ionic-liquid phase. Those show the structures before being supported by support Al₂O₃ or TiCl₄. A novel supported ionic-liquid phase product corresponds to that a compound of ionic liquid and Lewis acid is dispersed as a film shape on the inner surface of porous support. That is, acidic ionic liquid which is [BMIM]Cl/AlCl₃, [BMIM]Cl/TiCl₄ is supported by porous support Al₂O₃.

In the supported ionic liquid system, the degree of acid can be adjusted by the ratio of ionic liquid and AlCl₃ or TiCl₄ which are Lewis acid. They may be desirably used in an appropriate range of content for increasing the performance of the supported ionic liquid.

In the present invention, the concept of ‘supported ionic liquid phase’ may be defined as using non-volatile ionic liquid and using same kind of catalysts. This ionic liquid of novel concept has unique property.

For example, the unique properties are as followings:

1) It enables the phenomenon that physical force affects when solvation or various molecules, ions, colloidal particles and etc are dissolved to solvent, thereby molecule group is formed.

2) It enables stable experiment of compound of ionic liquid and metal.

3) It enables interaction of ionic liquid on the support.

The ionic-liquid phase product synthesized by the producing method of the present invention can be additionally subjected to vacuum evaporation. As a reaction solvent to be used for a reaction before supported by support, water only or mixed solvent of methylene chloride and water can be used. Removal of water through vacuum evaporation can be confirmed by using moisture analyzer as the example. The reaction can be conducted in general reaction flask.

In the producing method of the present invention, the concentration of BMIM-Cl compound is desirably from about 0.1 M to about 0.2 M, and the concentration of AlCl₃ or TiCl₃ which are Lewis acid is desirably from about 0.12 M to about 0.24 M for synthesis.

And, the reaction temperature of reactor is desirably from about 70° C. to about 80° C. In case of below 70° C., intermediate of ionic-liquid phase cannot be formed properly.

The vacuum evaporation step for synthesizing the intermediate of ionic liquid phase may be performed under 1 atmosphere, at a inner temperature of from about 70° C. to about 75° C. for about 1 hour to about 2 hours. And, it is preferred to maintain about from 755 torr to about 760 torr during evaporation. In case of below 755 torr during evaporation, evaporating efficiency would be decreased so that excess water would be remained. If the inner temperature of evaporating substance is low or the evaporating time is short, excess water would be remained. In accordance with the present invention, the water content of from about 100 ppm to about 150 ppm can be confirmed by using moisture analyzer.

Subsequently intermediate products [BMIM]Cl/AlCl₃, [BMIM]Cl/TiCl₄ are completely dissolved in a solvent including methylene chloride and water, and then dispersed and supported on a support Al₂O₃. It is preferred that the intermediate dissolved in the solvent is being stirred for about 1 hour and supported with Al₂O₃ in a weight ratio of 1:1 to 1:3 and then subjected to vacuum evaporation under 1 atmosphere, at a inner temperature of 50° C.˜55° C. for about 1 hour to about 2 hours.

In accordance with the producing method of the present invention, a thermally stable supported ionic-liquid phase product is provided.

### MODE FOR CARRYING OUT THE INVENTION

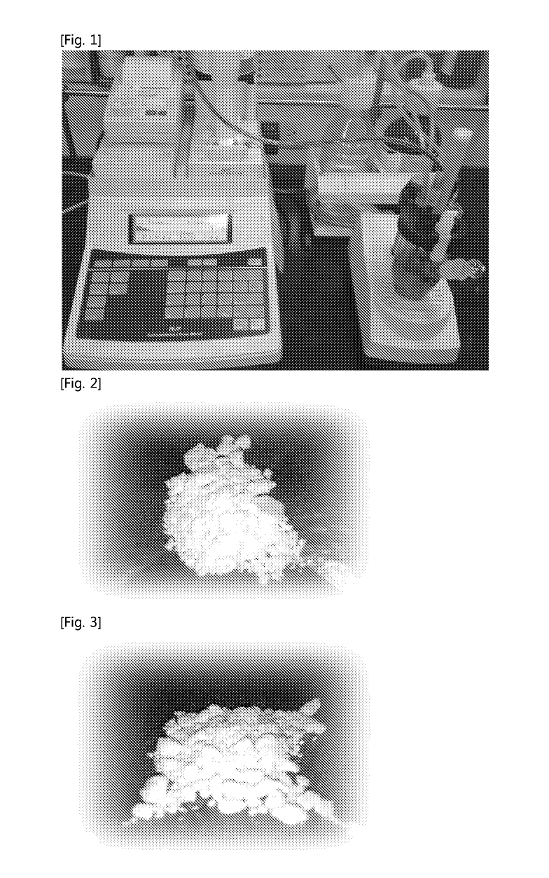

Hereinafter, the present invention will be explained in more detailed with reference to examples. However, the scope of the present invention is not limited thereto.

<Used Instrument>As the moisture analyzer, KEM Karl-Fischer Moisture Titrator Mks-510 (Japan) was used as shown in FIG. 1.

### Example 1

Preparation of 1-butyl-3-methylimidazoliumaluminumtetrachloride aluminiumoxide (BMIM-AlCl₄-Al₂O₃)

1-butyl-3-methylimidazolium chloride 34.93 g(0.2 M) was mixed with AlCl₃ 32 g (0.24 M), water 60 g was slowly added thereto by dropwise, and reacted at 70° C.˜80° C. for 24 hours. After the reaction end, it was subjected to vacuum evaporation (1 atmosphere, 70° C., 1 hour) to obtain liquid product 56.7 g (92%).

2 g of obtained ionic liquid was dissolved in methylene chloride and stirred with Al₂O₃ 4g for 1 hour. Obtained product therefrom was subjected to vacuum evaporation (1 atmosphere, 50° C., 1hour) and then BMIM-AlCl₄-Al₂O₃ compound which is supported ionic-liquid phase in a solid form (see FIG. 2) was obtained.

¹H NMR(CD₃OD, 400 MH_{z}) δ: 8.87(s,1 H), 7.55(d,1H), 4.12(s, 2H),3.83(s,3H), 1.77(s,2H), 1.29(q, 2H), 0.89(t, 3H).

TGA: 254.7° C.

### Example 2

Preparation of 1-butyl-3-methylimidazoliumtitaniumpentachloride Aluminiumoxide (BMIM-TiCl₅-Al₂O₃1

1-butyl-3-methylimidazolium chloride 34.93 g(0.2 M) was added to water 60 g and stirred. TiC1₄ 45.5 g (0.24 M) was slowly added thereto by dropwise, and reacted at 70° C.-80° C. for 24 hours. After the reaction end, it was subjected to vacuum evaporation(1 atmosphere, 70° C., 1 hour) to obtain liquid product 67.8 g (93%). 2 g of obtained ionic liquid was dissolved in methylene chloride and stirred with Al₂O₃ 4g for 1 hour. Obtained product therefrom was subjected to vacuum evaporation (1 atmosphere, 50° C., 1 hour) and then BMIM-TiCl₅—Al₂O₃ compound which is supported ionic-liquid phase in a solid form (see FIG. 3) was obtained.

¹H NMR(CD₃OD, 400 MH_{z}) δ: 8.942(s,1H), 7.623(d,1H), 4.200(s, 2H),3.911(s,3H), 1.847(s,2H), 1.351(q, 2H), 0.870(t, 3H).

TGA: 264.7° C.

1. A method for producing powder-type ionic-liquid phase product having thermal stability, wherein the method comprises: reacting 1-butyl-3-methylimidazolium chloride [BMIM]Cl with AlCl₃ or TiCl₄ as Lewis acid to synthesize intermediate of ionic-liquid phase; and a step of depositing Al₂O₃ which is a porous support to the intermediate.

2. The method according to claim 1, wherein
the 1-butyl-3-methylimidazolium chloride [BMIM]Cl and the AlCl₃ or TiCl₄ as Lewis acid are reacted in concentrations of from 0.1 M to 0.2 M and 0.12 M to 0.24 M, respectively.

3. The method according to claim 1, wherein
the intermediate of ionic-liquid phase is subjected to vacuum evaporation under 1 atmosphere, at 70° C.˜75° C. for 1˜2 hours during synthesizing process.

4. The method according to claim 3, wherein
the intermediate of ionic-liquid phase is produced by dissolving in a solvent including methylene chloride and water.

5. The method according to claim 4, wherein
the intermediate of ionic-liquid dissolved in the solvent is being mixed and stirred with Al₂O₃ as a support in a weight ratio of 1:1 to 1:3 and is being supported by Al₂O₃.

6. The method according to claim 1, wherein
the intermediate of ionic-liquid phase is subjected to vacuum evaporation under 1 atmosphere, at a inner temperature of 50° C.˜55° C. for about 1 hour to about 2 hours.
